(19) United States
(12) Patent Application Publication
(10) Pub. No.: US 2018/0189994 A1
(43) Pub. Date: Jul. 5, 2018

(54) METHOD AND APPARATUS USING AUGMENTED REALITY WITH PHYSICAL OBJECTS TO CHANGE USER STATES

(71) Applicant: THOMSON Licensing, Issy-les-Moulineaux (FR)

(72) Inventors: Regine Jeanne LAWTON, Newhall, CA (US); Chad Andrew LEFEVRE, Indianapolis, IN (US)

(21) Appl. No.: 15/738,803

(22) PCT Filed: Jun. 15, 2016
(86) PCT No.: PCT/US2016/037693

§ 371 Date: Dec. 21, 2017

Related U.S. Application Data
(60) Provisional application No. 62/186,929, filed on Jun. 30, 2015.

(51) Int. Cl. G06T 11/60; G02B 27/01; G09B 5/06

(52) U.S. Cl. CPC G06T 11/60; G02B 27/0101; G02B 2027/0138; G02B 2027/014; G09B 5/067

(57) ABSTRACT

A state of a user (user's state) may be determined. Such user states may include an engagement level of the user, an awakeness level of the user, a satisfaction level of the user, a lack of frustration level of the user, emotional level of the user, and/or any other user state. At least one physical object in the space/vicinity of the user may be recognized. Augmented reality may be used with the detected physical object to change the state of the user when the state is not at a threshold. For example, material may be visually presented to the user such that the material appears to be presented on the physical object.

### TECHNICAL FIELD OF THE INVENTION

Embodiments described herein relate generally to augmented reality and, more particularly, to using augmented reality with physical objects to change the state of a user in a space.

### BACKGROUND OF THE INVENTION

Users in a physical space may have a state of activity. For example, a user participating in an activity such as a classroom lecture may have an engagement level. If the user's engagement level is not sufficiently high, the user may not learn. By way of another example, a user operating a vehicle may have an awakeness level (or a converse drowsiness level). If the user's awakeness level is not sufficiently high (or the user's drowsiness level is too low), the user may have an accident.

Accordingly, there may be a present need for changing the state of a user in a space, vehicle, setting, and the like.

### SUMMARY

This summary is provided to introduce a selection of concepts in a simplified form that are further described in the Description of the Embodiments section below. This summary is not intended to identify key features or essential features of the claimed subject matter, nor is it intended to be used as an aid in determining the scope of the claimed subject matter.

Various exemplary embodiments described herein may relate to, include, or take the form of a method for using augmented reality with physical objects. The method may include: determining a state of a user in a space, detecting at least one physical object in the space/vicinity of the user, and using augmented reality with the detected at least one physical object to change the state of the user when the state is not at a threshold.

In some examples, the method and/or processing unit may be configured to determine the state of the user by determining an engagement level of the user with an educational activity involving the user in the space. In such examples, the processing unit may be configured to use the augmented reality with the detected at least one physical object by increasing the engagement level of the user with the educational activity. In various examples, the educational activity may be presented in a first mode and the processing unit may be configured to use the augmented reality with the detected at least one physical object by presenting material related to the educational activity with the detected at least one physical object in a second mode. The first mode may be audio and the second mode may be at least one of an image, a video, and an interactive element. In some examples, the processing unit may be further configured to receive an identification of the educational activity and select the material based on the identification.

In various examples, a method and/or processing unit may be configured to determine the state of the user by determining an awakeness level of the user while operating a vehicle. In such examples, the processing unit may be configured to use the augmented reality with the detected at least one physical object by providing a visual alert in a field of view of the user to increase the user's awakeness level.

In one or more examples, a method, and/or processing unit may be configured to detect the at least one physical object in the space by detecting that the at least one physical object is within an area viewable by the user as part of the augmented reality. The processing unit may be configured to determine the state of the user by at least one of receiving biometric data for the user and receiving analysis of at least one image of the user.

Related exemplary embodiments described herein may relate to, include, or take the form of computer program product tangibly embodied in a non-transitory storage medium. The computer program product may include a first set of instructions stored in the non-transitory storage medium executable by a processing unit to determine a state of a user in a space. The computer program product may further include a second set of instructions stored in the non-transitory storage medium executable by the processing unit to detect at least one physical object in the space. The computer program product may additionally include a second set of instructions stored in the non-transitory storage medium executable by the processing unit to use augmented reality with the detected at least one physical object to increase the state of the user when the state is below a threshold.

### BRIEF DESCRIPTION OF THE FIGURES

Reference will now be made to representative exemplary embodiments illustrated in the accompanying figures. It is understood that the following descriptions are not intended to limit the disclosure a particular embodiment or a set of particular embodiments. To the contrary, this disclosure is intended to cover alternatives, modifications, and equivalents as may be included within the scope of the described embodiments as defined by the appended claims and as illustrated in the accompanying figures:

FIG. 1 depicts an example of a user involved in an educational activity while using an augmented reality device;

FIG. 2A depicts an exemplary view presented to the user by the augmented reality computing device;

FIG. 2B depicts an exemplary view of FIG. 2A when the augmented reality computing device attempts to increase a state of the user using augmented reality with a physical object;

FIG. 3 depicts an exemplary block diagram of components and functional relationships of components that may be used in the augmented reality computing device;

FIG. 4A depicts an exemplary view presented to a user of a vehicular augmented reality computing device;

FIG. 4B depicts the exemplary view of FIG. 4A when the vehicular augmented reality computing device attempts to increase a state of the user using augmented reality with a physical object; and

FIG. 5 depicts an flow chart illustrating operations of an exemplary method of using augmented reality with physical objects.

The use of the same or similar reference numerals in different drawings indicates similar, related, or identical items.

### DESCRIPTION OF THE EMBODIMENTS

Various exemplary embodiments are described more fully below with reference to the accompanying drawings, which form a part hereof, and which show specific exemplary embodiments. However, embodiments may be implemented in many different forms and should not be construed as limited to the embodiments set forth herein. Rather, these embodiments are provided so that this disclosure will be thorough and complete, and will fully convey the scope of the embodiments to those skilled in the art. The following detailed description is, therefore, not to be taken in a limiting sense.

Augmented reality is a live view (direct or indirect) of a physical, real world space whose elements are augmented (or supplemented) by computing device generated sensory input. Such sensor input may include audio, images, video, graphics, positioning and/or direction information, and the like. For example, computing device generated visual information may be displayed on (and/or projected onto) a transparent screen through which a user can see a physical space. By way of another example, an electronic display may present live video of a physical space that is combined with additional computing device generated visual information. Thus, augmented reality may enhance a user's perception of a physical space, contrasted with virtual reality which may replace a physical space with a simulated space.

Many embodiments described herein relate to methods, systems, and computer program products for using augmented reality with physical objects. A state of a user (such as an engagement level of the user, an awakeness level of a user, a drowsiness level of a user, a satisfaction level of a user, an emotional level of the user, a lack of frustration level of a user, a frustration level of a user, and the like) in a space may be determined. At least one physical object in the space may be recognized or otherwise detected. Augmented reality may be used with the detected physical object (such as by providing one or more images at a visual position corresponding to the physical object) to change the state of the user when the state is at a threshold. In this way, augmented reality may be used with physical objects to change the state of a user in a space.

In many exemplary embodiments, the state of the user may be an engagement level of the user with an educational activity (such as a classroom lecture) involving the user in the space. In such an embodiment, using augmented reality to increase the state of the user may include increasing the engagement level of the user with the educational activity.

In some examples, the educational activity may be presented in a first mode (such as audibly through a lecture delivered by a processor) and using augmented reality to increase the engagement level of the user may include presenting material related to the educational activity with the detected object in a second mode (such as an image, video, or interactive element displayed as if on a physical object such as a blackboard in the space). In such an example, an identification of the educational activity may be received (such as by performing analysis of the audio of the lecture, receiving a communication that specifies a subject being discussed in the lecture, and the like) and the material may be selected based on the identification.

In various exemplary embodiments, the state of the user may be an awakeness level of a user operating a vehicle (such as a car, plane, and the like) in the space. Using augmented reality to increase the state of the user may include providing a visual alert in a field of view of the user to increase the user's awakeness level. Conversely, in some implementations, the state of the user may be a drowsiness level of the user and the visual alert may be provided in the field of view of the user to decrease the user's drowsiness level.

In some exemplary embodiments, detecting the physical object in the space may include detecting that the object is within an area viewable by the user as part of the augmented reality. For example, the physical object may be detected to be visible through a transparent screen or in a live video used in presenting the augmented reality to the user.

In various exemplary embodiments, the user's state may be determined in a variety of ways. In some examples, biometric data for the user may be received (such as the user's pulse or heart rate, pupil dilation, rate of blinking, breathing pattern, and/or any other biometric information regarding the user). In other examples, one or more images of the user may be analyzed (such as to determine where a user is looking, where a user's eyes are focused, whether or not a user is fidgeting, how often a user blinks, and the like).

In various embodiments, a user's specific emotional state may be determined where vital information of the user such as heart rate, pulse rate, temperature, blood vessel dilatation, conductivity of a user's skin, pupil dilation, facial expressions, body language, breathing pattern, chemical changes in bodily fluids and/or odor, and the like can indicate a specific emotional state (happy, sad, and the like) or a generic emotional state (high heart rate can indicate a person is excited, a slower heart rate can indicate that a person is relaxing, and the like). This information can be determined by a wearable device that takes vital signs worn by a user, an external sensory system that takes in visual input through a camera or KINECT, auditory input through an audio sensor, olfactory through a machine olfaction sensor, and other types of sensors, alone, or in combination.

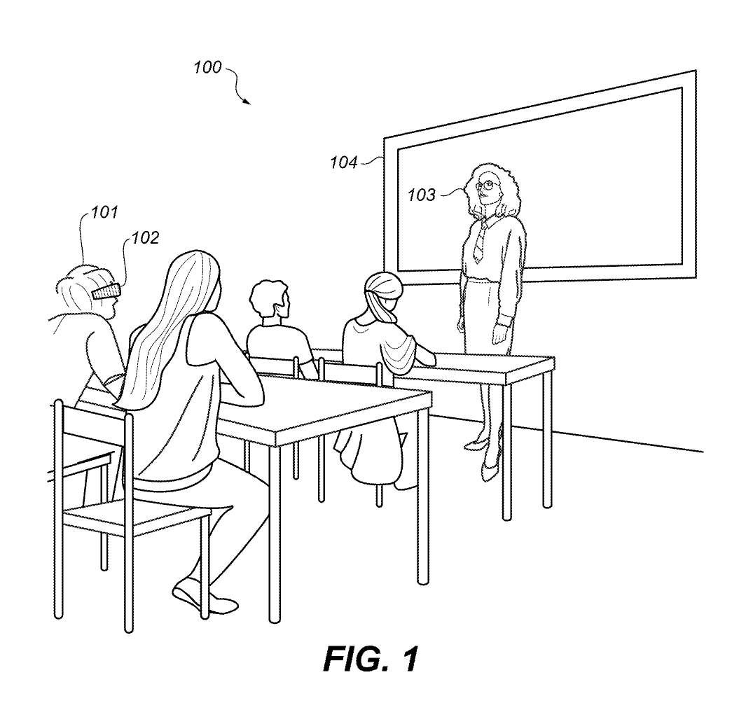

FIG. 1 depicts an exemplary space in accordance with the principles of the disclosure where a user 101 is involved in an educational activity while using an augmented reality device 102. As shown, the educational activity may be a classroom lecture presented in a classroom space 100 via a professor 103 lecturing to students including the user 101.

The augmented reality device 102 may be configured to perform a method of using augmented reality with physical objects to change a state of the user 101 in the classroom space 100. The augmented reality device 102 may determine the state of the user 101 in the classroom space 100, detect at least one physical object 104 in the classroom space 100, and use augmented reality with the detected at least one physical object to increase the state of the user 101 when the state is below a threshold.

For example, the state of the user 101 may be an engagement level of the user 101 with the classroom lecture. The user's 101 engagement level may be highly engaged if the user 101 is completely focused on the classroom lecture, engaged if the user 101 is mostly focused on the classroom lecture, somewhat engaged if the user 101 is mostly focused on something other than the classroom lecture but is focused in some way on the classroom lecture, and unengaged if the user 101 is not focused on the classroom lecture at all.

In such an example, determining the state of the user 101 may include determining the user's engagement level with the lecture being delivered in the classroom. The augmented reality device 102 may determine the user's 101 engagement level in a variety of ways. The augmented reality device 102 may include one or more components for (and/or that receive communications from one or more other devices that include such components) receiving biometric data for the user 101 (such as the user's pulse or heart rate, pupil dilation, rate of blinking, breathing pattern, and/or any other biometric information regarding the user) that indicates the user's 101 engagement level, analyzing one or more images of the user 101 to determine the user's 101 engagement level (such as to determine where a user is looking, where a user's eyes are focused, whether or not a user is fidgeting, how often a user blinks, and the like), and/or otherwise determining the user's 101 engagement level.

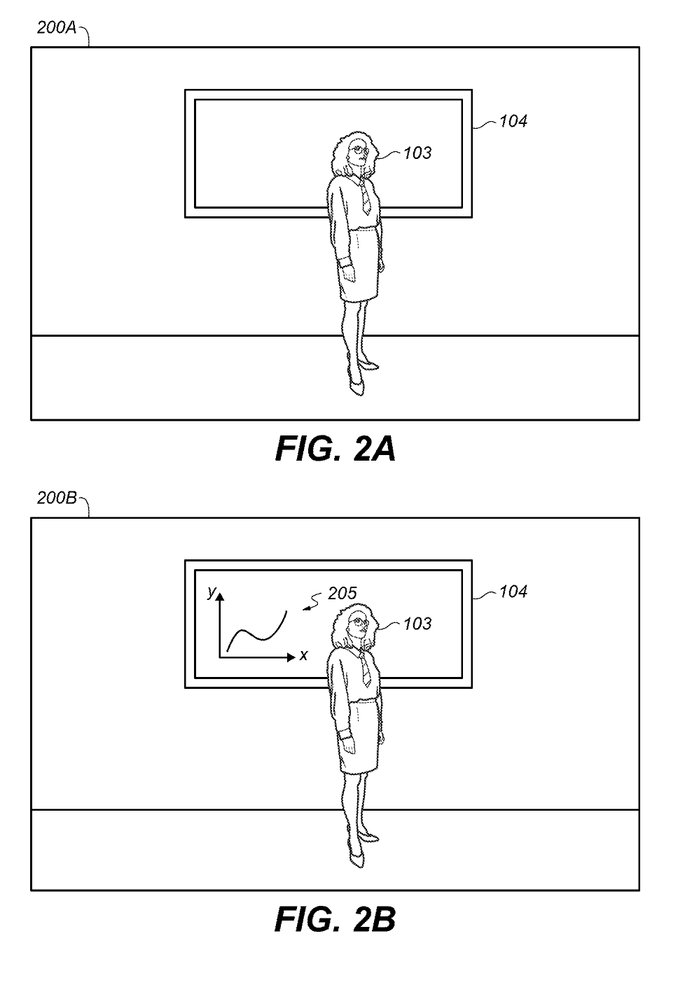

The augmented reality device 102 may detect and/or otherwise select or identify at least one physical object in the classroom space 100 which can be the vicinity of a user, if a user is present in space 100. Such detection may involve detecting that the physical object is within the classroom space 100, detecting that the physical object is within an area viewable by the user 101 as part of the augmented reality, detecting that the physical object has properties (such as the size, shape, and type of surface) where augmented reality can be presented, performing image recognition to recognize the physical object and/or properties of the physical object, detecting that the physical object is controllable by the augmented reality device 102, and the like. For example, as shown in FIG. 2A, the augmented reality device 102 may detect that the white board 104 behind the professor 103 is within an area 200A viewable by the user 101 as part of the augmented reality and has dimensions sufficient for the augmented reality device 102 to present material.

The augmented reality device 102 may use augmented reality with the detected at least one physical object to increase the state of the user 101 when the state is below the threshold. For example, as illustrated in FIG. 2B, if the user's 101 engagement level is somewhat engaged or below, the augmented reality device 102 may provide an image 205 in the area 200B viewable by the user 101 at a visual position corresponding to the white board 104. Providing the image 205 at the visual position corresponding to the white board 104 (or, according to the perception of the user 101, on the white board 104) may increase the engagement level of the user 101, resulting in the user 101 becoming more focused upon the classroom lecture.

In some exemplary implementations, the augmented reality device 102 may be configured to use augmented reality with the detected physical object to present material related to the educational activity in a different mode than the mode in which the educational activity is being presented. For example, the lecture shown in FIG. 2B is being presented in a first mode, audio, via the professor speaking. The presented material may be presented in a second mode, visually, via the image 205. Different people learn better via different modes and presentation using multiple modes may increase engagement. Such different modes may also clarify materials that are difficult for the user 101 to understand through only audio.

Although the image 205 is illustrated and described as an image 205, it is understood that this is an example. The second mode may be any kind of content presented in a different mode than the educational activity, such as one or more images, videos, interactive elements (such as games) and the like.

In various exemplary implementations, the augmented reality device 102 may be configured to select the material to present in such a way that the material is associated with the educational activity. The augmented reality device 102 may receive an identification of the educational activity and select the material based on the identification.

For example, the augmented reality device 102 may include a component that performs audio analysis on the lecture to determine that the lecture discussed a mathematical curve on a graph. A processing unit of the augmented reality device 102 may receive an indication of the subject matter of the lecture and may select the image 205 to graphically illustrate the graph.

By way of another example, a transmitter in the classroom 100 may transmit identifiers relating to the subject matter of the lecture. The augmented reality device 102 may receive such identifiers and may select the image 205 based on an association with the identifiers.

In still other examples, the augmented reality device 102 may be configured with a specification of what the lecture is covering. As such, when selecting the image 205, the augmented reality device 102 may select content associated with what is indicated in the specification.

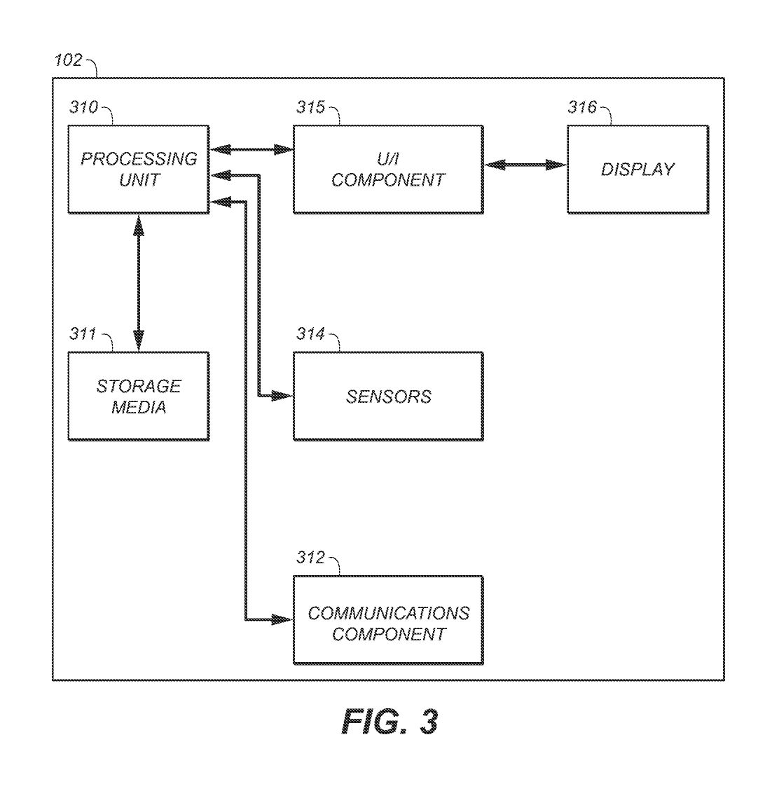

FIG. 3 depicts an exemplary block diagram of components and functional relationships of components that may be used in the augmented reality computing device 102. As illustrated, the augmented reality device 102 may include one or more processing units 310, storage media 311 (which may take the form of, but is not limited to, a magnetic storage medium, optical storage medium, magneto-optical storage medium, read only memory; random access memory, erasable programmable memory, flash memory, and the like), user interface components 315 (such as one or more displays 316, speakers, microphones, input/output devices, and the like), sensors 314 (such as one or more biometric sensors, still image cameras, video cameras, microphones, olfactory sensors, and the like), communication components 312, and the like. The processing unit 310 may execute one or more sets of instructions stored in the storage media 311 to perform various augmented reality device 102 functions. Different examples of augmented reality computing devices 102 can be GOOGLE GLASSES, HOLO LENS FROM MICROSOFT, SONY VITA, NINTENDO 3DS, and the like.

For example, execution of one or more such sets of instructions may configure the processing unit 310 to determine a state of a user in a space, detect at least one physical object in the space/vicinity of a user, and use augmented reality with the detected at least one physical object to increase the state of the user when the state is below a threshold. By way of another example, the processing unit 310 may be configured to perform various different methods for using augmented reality with physical objects and/or other functions associated with the augmented reality device 102.

In some exemplary implementations, the display 316 may be a transparent screen through which the user 101 can see a physical space such as the classroom space 100 and on which the display 316 can present visual information generated by one or more components of the augmented reality device 102 (such as the processing unit 310). For example, the display 316 may be a variable transparency liquid crystal screen that can be controlled such that the user can see through it and/or visual information can be presented thereon. By way of another example, the augmented reality device 102 may include components that project visual information on the display 316 such that the user 101 can view the projected visual information at the same time that the user 101 is looking through the transparent screen to see the physical space. In such an example, the visual information may be projected at infinity (e.g., refocusing to infinity used for a camera) such that the user 101 does not refocus his eyes when switching between looking at the physical space and the presented visual information.

In another exemplary disclosure, the display 316 may be a non-transparent display operable to present live video of a physical space such as the classroom space 100 combined with generated visual information. For example, such a combination may be a video feed of the classroom 100 enhanced with the image 205, as shown in FIG. 2B.

Although FIGS. 1-3 are exemplary and described in the context of changing a user's 101 engagement level with an educational activity, it should be understood that this is an example. Various implementations are possible and contemplated without departing from the scope of the present disclosure.

For example, the user 101 participating and/or otherwise involved in the lecture shown presented in FIG. 1 may have a frustration level, an awakeness level, a satisfaction level, a lack of frustration level, and/or any other kind of state. Such states may be monitored and augmented reality may be used with such detected states to alter the detected states, such as to increase a user's 101 lack of frustration level (which may correspond to their confusion with respect to lecture presented material) and the like.

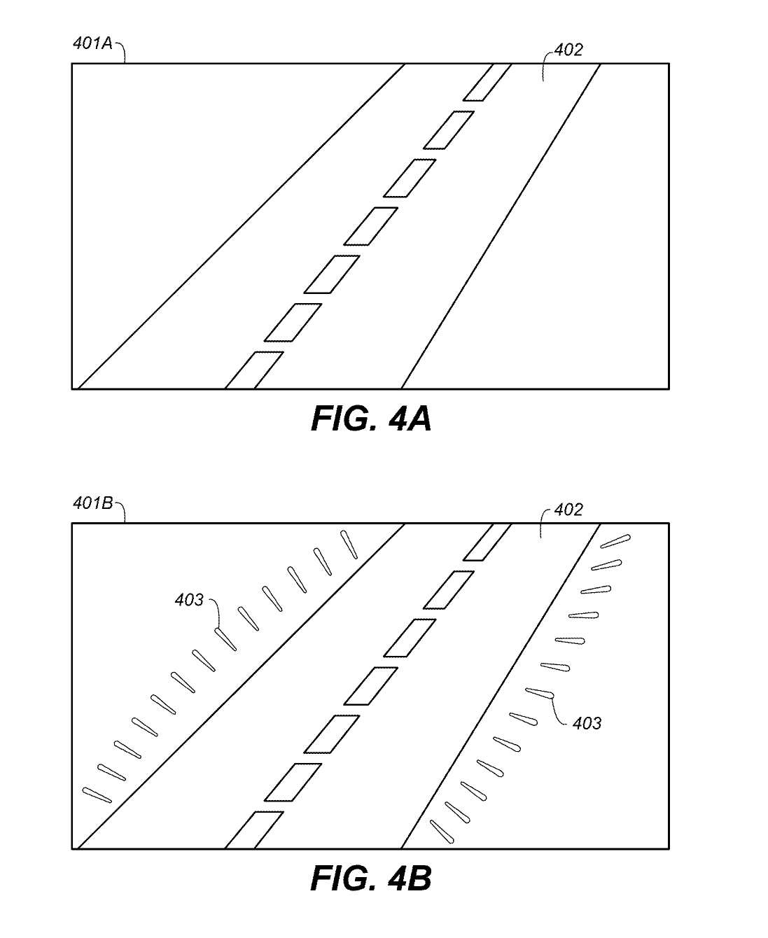

By way of another example, FIG. 4A depicts an exemplary view 401A presented to a user of a vehicular augmented reality computing device. The user may be operating the vehicle (such as a car, plane, boat, and the like) and may have an awakeness level (or a converse drowsiness level and/or other related level). Operating a vehicle when not sufficiently awake may be dangerous. As such, the vehicular augmented reality computing device may use augmented reality with a detected physical object to increase the awakeness level of the user.

For example, the vehicular augmented reality computing device may determine that the road 402 is within the view 401A of the user. The vehicular augmented reality computing device may use augmented reality with the road 402 to increase the awakeness level of the user, such as by providing the flashing danger indicators 403 of the view 401B illustrated in FIG. 4B and/or another visual alert in a field of view of the user. The flashing danger indicators 403 may indicate to the user that the user is less than safely awake and needs to wake up more. This conveyed danger may wake the user up more, increasing the user's awakeness level.

By way of another example, a user may be utilizing an augmented reality computing device while composing a word processing document on a home computing device. The user may become frustrated when unable to figure out how to accomplish something in the associated word processing program. When the user's lack of frustration level goes below a threshold, the augmented reality computing device may detect the monitor of the home computing device and may present help information on a screen of the monitor in areas that do not conflict with word processing program areas being utilized by the user.

By way of another example, a user may be utilizing an augmented reality computing device while watching television. Advertisements may be displayed on the television. If the ads are displayed for too long, a satisfaction level of the user may go below a threshold and the user may not attend to the ads. As such, the augmented reality computing device may detect a portion of a wall that is in the user's view along with the television and display dancing animations thereon. The dancing animations may entertain the user sufficiently that the user's satisfaction level increases above the threshold while still viewing the ads. In this way, the user's satisfaction level may be kept above the threshold while the user still views the ads.

By way of another example, a user may be utilizing an augmented reality computing device while consuming media like a video or audio. The computing device can be interfaced with a set top box and/or display device where the computing device is aware of what content the user is consuming. If an critical scene or element in the content is presented where the state of the user appears to be waning, an object in the physical space/vicinity of the user can be detected and used to draw the user's attention back to the display device. The object can morph into a cartoon character and provoke the user to focus back to viewing the program.

By way of another example, a user may be utilizing an augmented reality computing device while participating in a video conference. That is, a particular user in the conference may be caused to pay attention if it is determined that the user's attention is fading during the teleconference. A physical object in the vicinity of the user can be caused by the augmented reality device to have the object “change” into a cartoon character and tell the user to focus on the conference.

Although exemplary FIGS. 1-4B are illustrated and described in the context of overlaying visual information on a physical object, it should be understood that this is an example consistent with the presented. In various exemplary implementations, the detected physical object may be used with augmented reality in various other ways without departing from the scope of the present disclosure.

For example, the detection may detect that the object can perform one or more functions and is controllable and/or can otherwise be utilized by an augmented reality computing device to perform a function. Such a function may be to display material instead of having the augmented reality computing device project the material on the object and/or otherwise display the material with the object, to produce audio, produce a haptic output such as a buzz or other vibration produced by a device worn by the user, and/or any other function.

As illustrated and described above, the augmented reality computing device may present material in a second mode when a user's state is below a threshold during presentation of educational or other activities in a first mode. However, it is understood that this is an example and in various implementations the augmented reality computing device may vary (and/or signal to be varied) various aspects of such activities without departing from the scope of the present disclosure.

For example, evaluation of the state of the user may enable presentations to be adjusted real time to focus more on topics a user finds more engaging. Alternatively, when a user is less engaged it may be determined that the user may need additional help or additional presentation of topics the user may be missing. In another alternative, evaluation of user state may allow allocation of more time to topics a user finds challenging in order to better explain and/or reinforce those topics. In still other alternatives, interactivity of lessons may be increased when a user's focus begins to slip in order to attempt to recapture the user's attention.

In other exemplary implementations, a user's comfort level or anxiety level may be evaluated instead of a focus. Various user states may be evaluated and responded to without departing from the scope of the present disclosure.

In still other exemplary implementations, a user's state may be tracked over time and evaluated. The user may be more focused at certain times of day and less focused on others. Based on such evaluation, presentation of materials may be adjusted to present certain materials at times the user may be more focused and other materials at times the user may be less focused. In various examples, such data regarding the user may be aggregated with data from other users. Such aggregation may be used to evaluate the effectiveness of materials, presenters, and the like and the materials and/or presenter may be adjusted based on evaluation of such aggregate data to increase effectiveness and/or perform other related functions.

In addition to modification of presentations based on detected user states, outside activities related to presentations may be performed in some implementations. For example, when a user's focus is detected to fall below a threshold during a lecture, homework tailored for the user accordingly may be sent to the user. The homework may be tailored based on the user's state falling below the threshold to further develop topics the user may have missed, have the user work on areas that the user may be having trouble with, provide more challenge in areas the user may have already mastered, and the like.

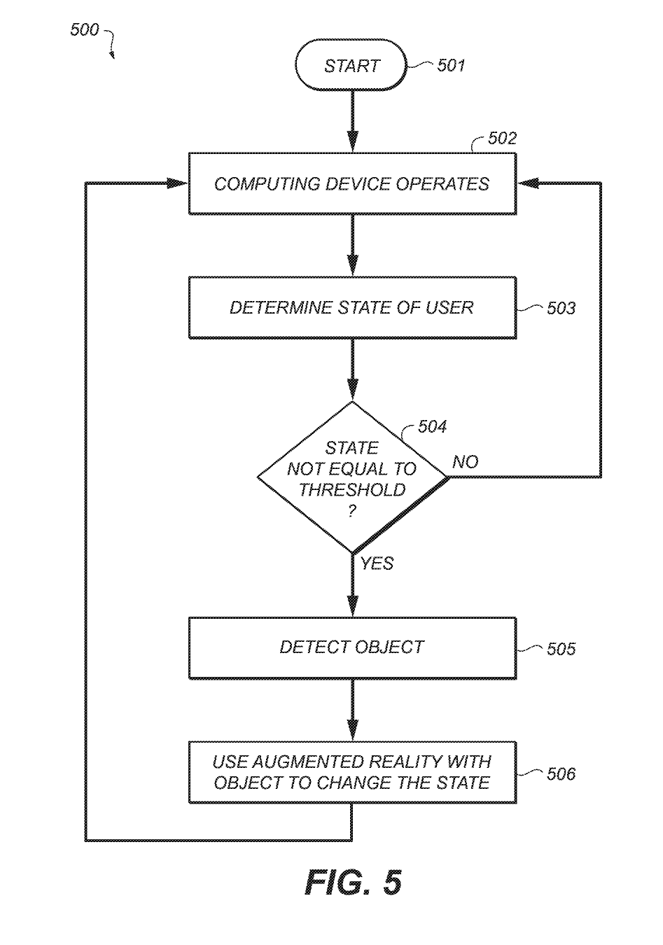

FIG. 5 depicts an exemplary flow chart illustrating operations of an method 500 of using augmented reality with physical objects. The method 500 may be performed by the augmented reality computing device 102.

At 501, the flow may start. The flow may proceed to 502 where a computing device operates. The flow may then proceed to 503 where a state of a user is determined. The state may be an engagement level of a user, an awakeness level of a user, a satisfaction level of a user, a lack of frustration level of a user, and/or any other user state that may be monitored.

Next, the flow may proceed to 504 where it is determined if the state is not at threshold. For step 504, the state not being at a threshold can be the state is below a threshold, the state is above a threshold, and/or the state is not equal to a threshold. If the state is not at a threshold, the flow may proceed to 505. Otherwise, the flow may return to 502 where the computing device continues to operate.

At 505, after the user's state is determined to not be at threshold, a physical object may be detected in the space/vicinity of the user. The flow may then proceed to 506 where augmented reality is used with the physical object. Augmented reality may be used with the physical object to increase the state of the user, decrease the state of the user, and/or otherwise alter or change the state of the user. In some exemplary embodiments, a determination is made to validate that an physical object is within the vicinity (in the same physical space) of a user.

The flow may then return to 502 where the computing device continues to operate. However, it should be understood that this is an example. In various implementations, the state of the user may be evaluated and augmented reality may be used with the physical object if the user's state is not yet sufficiently changed.

Although the example method 500 is illustrated and described above as including particular operations performed in a particular order, it is understood that this is an example. In various implementations, various orders of the same, similar, and/or different operations may be performed without departing from the scope of the present disclosure.

For example, the example method 500 is illustrated and described as determining whether or not the state of the user is below a threshold prior to detecting the object. However, in other implementations, the object may be detected before evaluation of the threshold.

In still other exemplary implementations, the evaluation of the threshold may be other than determining whether or not the state of the user is below a threshold. For example, in various implementations it may be determined whether or not the user's state is above a threshold. In other examples, the user's state may be compared against multiple thresholds without departing from the scope of the present disclosure.

As described above and illustrated in the accompanying figures, the present disclosure details embodiments related to methods, systems, and computer program products for using augmented reality with physical objects. A state of a user (such as an engagement level of the user, an awakeness level of a user, a drowsiness level of a user, a satisfaction level of a user, a lack of frustration level of a user, a frustration level of a user, and the like) in a space may be determined. At least one physical object in the space may be recognized or otherwise detected. Augmented reality may be used with the detected physical object (such as by providing one or more images at a visual position corresponding to the physical object) to increase the state of the user when the state is below a threshold. In this way, augmented reality may be used with physical objects to change the state of a user in a space.

In the present disclosure, the methods disclosed may be implemented as sets of instructions or software readable by a device. Further, it is understood that the specific order or hierarchy of steps in the methods disclosed are examples of sample approaches. In other embodiments, the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may take the form of, but is not limited to, a magnetic storage medium (e.g., floppy diskette, video cassette, and the like), optical storage medium (e.g., CD-ROM), magneto-optical storage medium, read only memory (ROM), random access memory (RAM), erasable programmable memory (e.g., EPROM and EEPROM), flash memory, and the like.

Although embodiments which incorporate the teachings of the present disclosure have been shown and described in detail herein, those skilled in the art can readily devise many other varied embodiments that still incorporate these teachings. Having described exemplary embodiments of a system and method for augmented reality (which are intended to be illustrative and not limiting), it is noted that modifications and variations can be made by persons skilled in the art in light of the above teachings. It is therefore to be understood that changes may be made in the particular embodiments of the disclosure disclosed which are within the scope of the disclosure as outlined by the appended claims.

For purposes of this application and the claims, using the exemplary phrase “at least one of A, B and C,” the phrase means “only A, or only B, or only C, or any combination of A, B and C.”

1-24. (canceled)

25. A method comprising:
determining via a processor a state of a user's alertness by monitoring level of user activity in a first time period;
detecting at least one physical object in the vicinity of the user; and
using a processor to enable at least one detected physical object to change (506) the state of the user's alertness when said alertness is below an amount.

26. A computing device, comprising:
a processing unit; and
a memory, coupled to the processing unit, storing instructions which, when executed by the processing unit, configures the processing unit to:
determine a state of a user's alertness in a space;
detect at least one physical object in the vicinity of the user; and
use said processor to detect at least one physical object to change the state of the user's alertness when said alertness is below an amount.

27. The method of claim 25, wherein said processor provides an augmented reality environment.

28. The method of claim 27, wherein the educational activity is presented in a first mode and the operation of using the augmented reality with the detected at least one physical object comprises presenting material related to the educational activity with the detected at least one physical object in a second mode and wherein the first mode comprises audio and the second mode comprises at least one of an image, a video, and an interactive element.

29. The method of any of claim 25, wherein the state of alertness is monitored by the level of at least one biometric data including a user's pulse or heart rate, pupil dilation, rate of blinking, or breathing pattern.

30. The method of any of claim 25, wherein said physical object is any device that can provide an auditory, haptic or other effects including an image, sound, smell or sense of touch.

31. The method of claim 25, wherein the operation of determining the state of the user's alertness comprises determining an engagement level of the user with an educational activity involving the user in the space.

32. The method of claim 29, wherein:
the operation of determining the state of the user comprises determining an awakeness level of the user while operating a vehicle; and
the operation of using the augmented reality with the detected at least one physical object comprises providing a visual alert in a field of view of the user to increase the user's awakeness level.

33. The method of claim 29, wherein the operation of detecting the at least one physical object in the vicinity of the user comprises detecting that the at least one physical object is within an area viewable by the user as part of the augmented reality.

34. The method of claim 29, wherein the operation of determining the state of the user comprises at least receiving one of:
receiving biometric data for the user; and
receiving analysis of at least one image of the user.

35. The method of claim 27, wherein the operation of using the augmented reality with the detected at least one physical object comprises providing an image at a visual position corresponding to the at least one physical object.

36. The method of claim 29, wherein the state of the user comprises at least one of:
an engagement level of the user;
an awakeness level of the user;
a satisfaction level of the user;
emotional state of the user; and
a lack of frustration level of the user.

37. The computing device of claim 26, wherein the processing unit is further configured to:
receive an identification of the educational activity; and
select the material based on the identification.

38. The computing device of claim 26, wherein:
the processing unit is configured to determine the state of the user by determining an awakeness level of the user while operating a vehicle; and
the processing unit is configured to use the augmented reality with the detected at least one physical object by providing a visual alert in a field of view of the user to increase the user's awakeness level.

39. A non-transitory storage medium carrying instructions of program code for executing steps of the method according to claim 25, when said program is executed on a computing device.
